(19) United States
(12) Patent Application Publication
(10) Pub. No.: US 2008/0147439 A1
(43) Pub. Date: Jun. 19, 2008

(54) User recognition/identification via speech for a personal health system

(76) Inventor: Richard L. Maliszewski, Forest Grove, OR (US)

Correspondence Address: INTEL CORPORATION;c/o INTELLEVATE, LLC, P.O. BOX 52050, MINNEAPOLIS, MN, 55402, US

(21) Appl. No.: 11/639,523

(22) Filed: Dec. 14, 2006

(51) Int. Cl. G06F 17/30

(52) U.S. Cl. 705/2

(57) ABSTRACT

Speaker recognition/identification technology may be used to recognize/identify a patient who intends to use a personal health system (“PHS”) and to match collected data to the profile of a right patient. The PHS may be used by multiple patients simultaneously at different locations via a center console or a remote peripheral.

### BACKGROUND

1. Field

This disclosure relates generally to a personal health system, and more specifically but not exclusively, to method and apparatus for identifying a user using the voice recognition technology.

2. Description

A Personal Health System (PHS) gathers patient data readings from approved medical peripherals, aggregates this data, forwards it to a medical facility, and may also perform trending and other analysis on the data. As currently specified, the first version of PHS is a single-user device, and peripherals are connected to the PHS platform via USB or Bluetooth. The PHS is intended to support multiple-user scenarios in the near future. These will likely include multi-patient homes and nursery homes. When multiple patients may use the same PHS, it is necessary to recognize a patient correctly and match data collected from this patient to a right profile. Therefore, it is desirable to employ patient recognition technologies to recognize a patient whether the patient uses the PHS at the center console or at a remote peripheral of the PHS.

### BRIEF DESCRIPTION OF THE DRAWINGS

The features and advantages of the disclosed subject matter will become apparent from the following detailed description of the subject matter in which:

FIG. 1 is a diagram of one example system that a personal health system (“PHS”) may collect measurement data from different patients at different locations;

FIG. 2 is a diagram of one example system where a PHS uses speaker recognition technology to recognize/identify a patient and match data collected from the patient to a correct profile;

FIG. 3 is a flowchart of one example process for a PHS to collect data from a patient and to match the data so collected to a correct profile; and

FIG. 4 is a diagram of an example computing system which may be used to implement a PHS with speaker recognition/identification capability.

### DETAILED DESCRIPTION

According to embodiments of the subject matter disclosed in this application, speaker recognition/identification technology may be used to recognize/identify a patient who intends to use a personal health system (“PHS”) and to match collected data to the profile of a right patient. The PHS may be used by multiple patients at different locations via a center console or a remote peripheral. The center console and the remote peripheral is equipped with a voice input/output device to playback prompt from the PHS and to collect voice data from a patient. The peripheral then sends the voice data to the PHS. The PHS uses the voice data collected from either the center console or a peripheral recognize/identify the patient. If the patient is correctly recognized/identified, the patient's profile will be retrieved and measurement taken from the patient may be added in the profile. When multiple patients use the PHS simultaneously at different locations, the PHS may recognize each of the patients and correctly store measurement data from each patient to his/her profile.

Reference in the specification to “one embodiment” or “an embodiment” of the disclosed subject matter means that a particular feature, structure or characteristic described in connection with the embodiment is included in at least one embodiment of the disclosed subject matter. Thus, the appearances of the phrase “in one embodiment” appearing in various places throughout the specification are not necessarily all referring to the same embodiment.

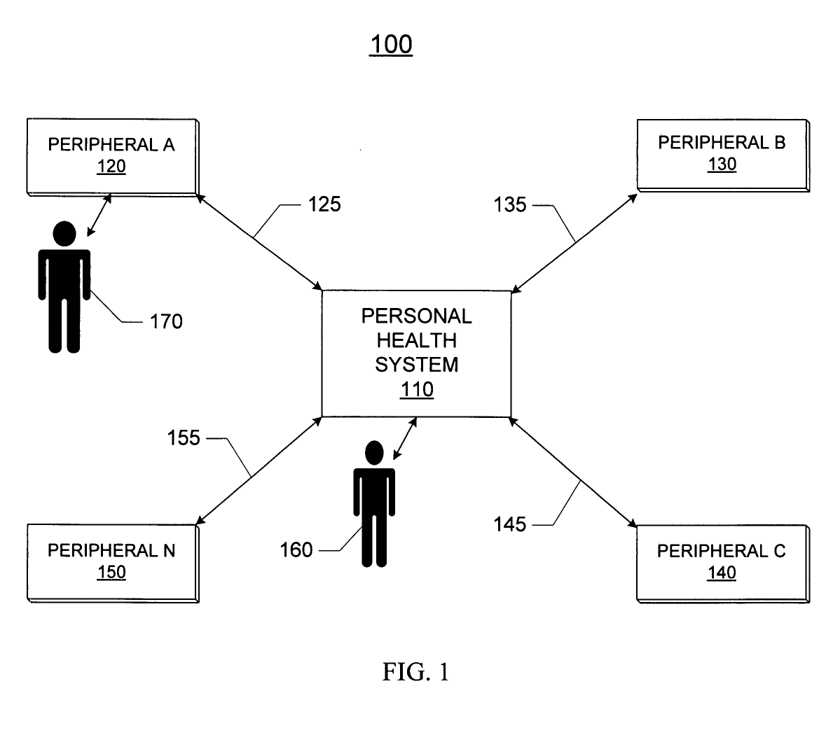

FIG. 1 is a diagram of one example system 100 that a personal health system (“PHS”) may collect measurement data from different patients at different locations. System 100 may comprise a PHS 110 and a number of peripherals such as peripheral A 120, peripheral B 130, peripheral C 140, and peripheral N 150. PHS 110 itself may include a center console which has a user interface (not shown in the figure) so that a patient (e.g., person 160) may login in to the PHS directly and access his/her profile. Peripherals may include any approved medical device. For example, Peripheral A 120 may be a scale; peripheral B 130 may be a blood pressure measurer; peripheral C 140 may be a cholesterol measuring device; peripheral N may be a heart monitoring device; and etc.

Peripherals may be connected to PHS 110 using different approaches. For example, peripheral A 120 may connect to the PHS via a USB (Universal Serial Bus) wire 125; peripheral B 130 may connect to the PHS via a Bluetooth® wireless channel 135; peripheral C 140 may connect to the PHS via a Wi-Fi (Wireless Fidelity) wireless channel 145; peripheral N 150 may connect to the PHS via a WiMAX (Wireless Max) wireless channel 155. These are only a few examples for connections between a peripheral and the PHS. In fact, any wired or wireless technology may be used for connecting a peripheral with the PHS. Additionally, a peripheral may be connected with the PHS via different channels at the same time or at different times. For example, a USB wired channel, a Bluetooth® wireless channel, and a WiMAX wireless channel may exist between a peripheral and the PHS at the same time or at a different time. The peripheral or a user may choose which channel is used during what time period.

PHS 110 may be used in different ways. In one scenario, a patient may access PHS 110 at different locations. For example, a patient may check his data at the center console; he may measure his blood pressure at one peripheral (e.g., peripheral. B 130) at a different time and have the measure data stored in his profile in the PHS. In another scenario, multiple patients may access PHS 110 simultaneously from different locations. For example, person 160 may access the PHS directly at the center console of the PHS; person 170 may access the PHS through peripheral A 120. When multiple patients use a PHS, it is necessary for the PHS to recognize a patient and retrieve the correct profile for the patient. In fact, the privacy law requires that a patient record be kept confidential and not accessed by another person who does not have a lawful right to do so. Even if a PHS is intended to be used by a single user, it is still desirable for the PHS to identify a user as the desired patient before letting the user access the patient's data.

According to an embodiment of the subject matter disclosed in this application, speaker recognition/identification technology may be used for patient recognition and identification. For example, when a user starts using a peripheral or tries to access a PHS through its center console, the user may be prompted to speak a phrase/sentence (e.g., the user's name). For a single-user PHS, the PHS may process the phrase/sentence and tries to identify the user by comparing the processed phrase/sentence with the intended user's model in a database. If the user is identified as the intended user, the PHS will authorize the user to use the peripheral or the center console. For a multi-user PHS, on the other hand, the PHS may process the phrase/sentence and tries to recognize the user by comparing the processed phrase/sentence with models of a number of PHS's intended users. If the user's speech matches with one model, the PHS may verify with the user whether s/he is indeed the recognized user. If the answer is positive, the PHS may pull the user's profile from a database and authorize the user to use the peripheral or the center console. In case that a user fails during the identification/recognition process, the user may be prompted to speak the same phrase/sentence or a different one again. The PHS may perform the identification/recognition process again based on the newly collected phrase/sentence. If the user passes the identification/recognition process this time, the PHS may authorize the user to use the system; otherwise, the user may be asked to go through the identification/recognition process again. If the user continues failing the identification/recognition process for a number of times (e.g., 3 times), the PHS may reject the user and does not allow the user to use the peripheral or the center console.

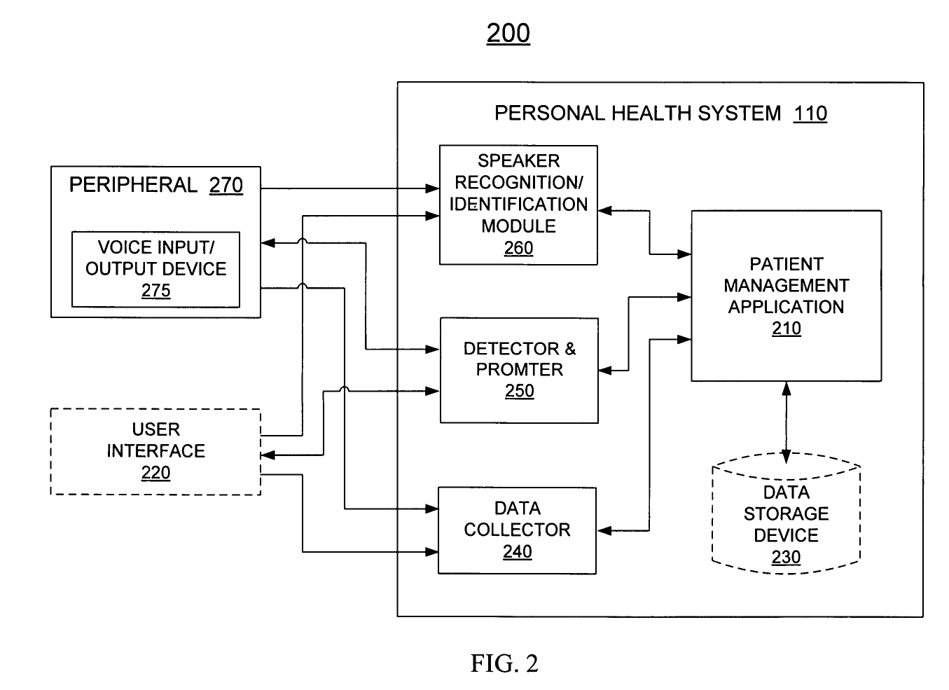

FIG. 2 is a diagram of one example system 200 where a PHS uses speaker recognition/identification technology to recognize/identify a patient and match data collected from the patient to a correct profile. System 200 may comprise a PHS 110, at least one peripheral 270, and a user interface 220. User interface 220 may be used for a user to interact with PHS 110 via its center console. User interface 220 may support voice input/output capability so that a user can speak to the PHS and hear prompts and responses from the PHS. User interface may also support other input/output capabilities such as a touch screen, a keyboard, a mouse, etc. In one embodiment, the user interface may be an integrated part of PHS 110. In another embodiment, the user interface may be separate from but coupled to PHS 110.

PHS 110 may comprise a patient management application 210, a data storage device 230, a data collector 240, a detector & prompter 250, and a speaker recognition/identification module 260. Patient management application 210, data collector 240, detector & prompter 250, data storage device 230, and speaker recognition/identification module 260 each may be implemented using pure software codes, pure hardware components, or a combination of software and hardware. Each of the above components in PHS 110 may run in or in connection with a computing system that has at least one processor (not shown in the figure).

In one embodiment, patient management application 210 may be a software application running on a processor of a computing system. Among many functions it may perform, the patient management application may pull the patient profile from data storage device 230 after a patient is identified or recognized correctly. The patient management application may then receive measurement data from a peripheral or the center console through data collector 240 and store the data into the patient profile. In one embodiment, the measurement data from the peripheral or the center console may be stored along with the patient profile in the patient's medical record stored in data storage device 230. A patient may decide to have more than one measurement done. If this is the case, the patient management application may aggregate all of the new measurement data from the same patient together, forward the data to a medical facility, and/or may further perform some analysis on the data. For example, the patient management application may perform trending analysis on the data. If it is found that there is anything abnormal with the patient, the patient management system may send an alert to the patient's doctor and/or the patient himself/herself. Furthermore, patient management application 210 may control and/or coordinate among other components of PHS 110 such as data collector 240, detector & prompter 250, and speaker recognition/identification module 260.

Detector & prompter 250 may detect a patient who is trying to use PHS 110 through a peripheral or the center console. A patient may be detected when the patient press one key at a peripheral or the center console, or when the patient tries to use measurement device at a peripheral or the center console. Once a patient is detected, detector & prompter 250 may prompt the patient to speak a phrase/sentence. Patient management application 210 may then direct speaker recognition/identification module 260 to receive the patient speech, which processes it and uses it to perform patient recognition/identification. If the patient is correctly recognized/identified, detector & prompter may then inform the patient that s/he can now use the peripheral or the center console; otherwise, the patient may be re-prompted to either repeat the phrase/sentence or speak a new phrase/sentence. If speaker recognition/identification fails more than a certain number of times (e.g., 3 times), detector & prompter 250 may inform the patient that s/he cannot use the system right now and suggest him/her to contact a service representative.

After a patient is successfully recognized in the situation when the PHS is intended to be used by multiple users, detector & prompter 250, under the direction of patient management application 210, may further confirm with the patient via voice or some other means (e.g., screen display if available) if the patient is indeed the recognized one. For example, the director & prompter may ask the patient via voice, “You are Karen Smith, right?” If the answer is positive, the director & prompter may say, “Thank you, you may now use the device.” In one embodiment, the director & prompter or the patient management application may include a speech synthesis module to synthesize any prompt or response to a patient. In another embodiment, no speech synthesis module may be necessary and the detector & prompter or the patient management application may pre-record prompts and responses if the number of prompts and responses is limited.

Speaker recognition/identification module 260 may include several components (not shown in the figure) such as a pre-processor, a feature extractor, and a pattern recognizer. The pre-processor may receive speech signal from user interface 220 or peripheral 270, convert the signal to digital form, pre-emphasize the signal to compensate for transmission loss at certain frequency ranges. The feature extractor may segment the pre-processed speech signal into overlapped frames and to extract features from each frame. A number of types of features may be extracted, which may include energy, zero-crossing rate, formants, mel-frequency cepstral coefficient (MFCC), etc. Each frame is represented by a feature vector which may include a single type of feature (e.g., MFCCs) or a combination of a few speech features. After feature extraction, an input speech signal is represented by a sequence of a feature vectors.

The pattern recognizer in speaker recognition/identification module 260 may compare the feature vector sequence with one or more templates or models. For speaker identification, typically there is one template or model for an intended patient; and the pattern recognizer compares the feature vector sequence with the template or the model. If the feature vector sequence matches the template or the model, the user is identified as the intended patient; otherwise, the user may be asked to go through the identification process again. For speaker recognition, there may be multiple templates or models, each for one of multiple intended users. The pattern recognizer compares the feature vector sequence with each of the templates or models to find the best match for the vector sequence. In one embodiment, the user may be recognized as the patient corresponding to the best matched template or model. In another embodiment, the pattern recognizer may further determine whether match between the feature vector sequence and the best matched template or model is close enough. If the answer is positive, the user may be recognized as the patient corresponding to the best matched template or model; otherwise, the pattern recognizer may decide that the user cannot be recognized as any of the intended users (i.e., the user fails the recognition process) and the user may be asked to go through the recognition again. After the user fails the recognition/identification process for a number of times (e.g., 3 times), the user may be rejected by the system.

The pattern recognizer in speaker recognition/identification module 260 may choose one of several available technologies for comparing the feature vector sequence and template(s) or model(s). For example, the pattern recognizer may use hidden Markov model (HMM) based technology, based on which an HMM is trained using speeches collected from each intended patient and is used as this patient's model. A Viterbi approach is used to compute a likelihood score for the feature vector sequence to match each of the HMMs. An intended patient whose HMM produces the highest likelihood score may be considered as the candidate for the user. In one embodiment, the pattern recognizer may further determine if the highest likelihood score is below a pre-determined threshold. If it is, the pattern recognizer may decide that the user cannot be recognized as the candidate patient and the user may be asked to try again by submitting another piece of speech.

Peripheral 270 may include a voice input/output (I/O) device 275, which plays prompt or response from PHS 110 to the user and accepts a user's speech. Voice I/O device 275 may be simply a headset including a microphone and a loudspeaker. Peripheral 270 may use a wireless technology to connect to PHS 110. In such a case, all the connections between peripheral 270 and PHS components (e.g., speaker recognition/identification module 260, detector & prompter 250, and data collector 240) for data and control signal transmission may be through wireless channels. When peripheral 270 is a Bluetooth® device, the peripheral may need to be upgraded to support the Bluetooth® headset profile.

Once a patient is successfully recognized/identified, patient management application 210 may direct detector & prompter 250 to prompt the patient to proceed to conduct any medical measurement, and direct data collector 240 to collect any medical measurement data from a peripheral or the center console, and transmit such data to the patient management application. In one embodiment, data collector 240 may directly store the measurement data in the patient profile or the patient medical record in data storage device 230. Data collector 250 may include circuitry to perform simple processing for raw measurement data from a peripheral or the center console. For example, if the raw measurement data is analog data, the data collector may convert it into a digital form.

In the above description, it is assumed that peripheral 270 only connect a user's speech without any further processing. In another embodiment, peripheral 270 may have sufficient computing power to performing a certain amount of processing for received speech. For example, some or all of the pre-pre-processing and/or feature extraction work may be performed by peripheral 270. In other words, the workload of speaker recognition/identification may be distributed between peripheral 270 and PHS 110. In such a situation, instead of directly transmitting raw speech to PHS 110, peripheral 270 transmits intermediate results (e.g., pre-processed speech signal or extracted speech feature vector sequence) to PHS 110. If only speech features are transmitted from peripheral 270 to PHS 119, the bandwidth requirement for the transmission channel may be reduced. Similarly, the workload of speaker recognition/identification may also be distributed between user interface 220 and PHS 110.

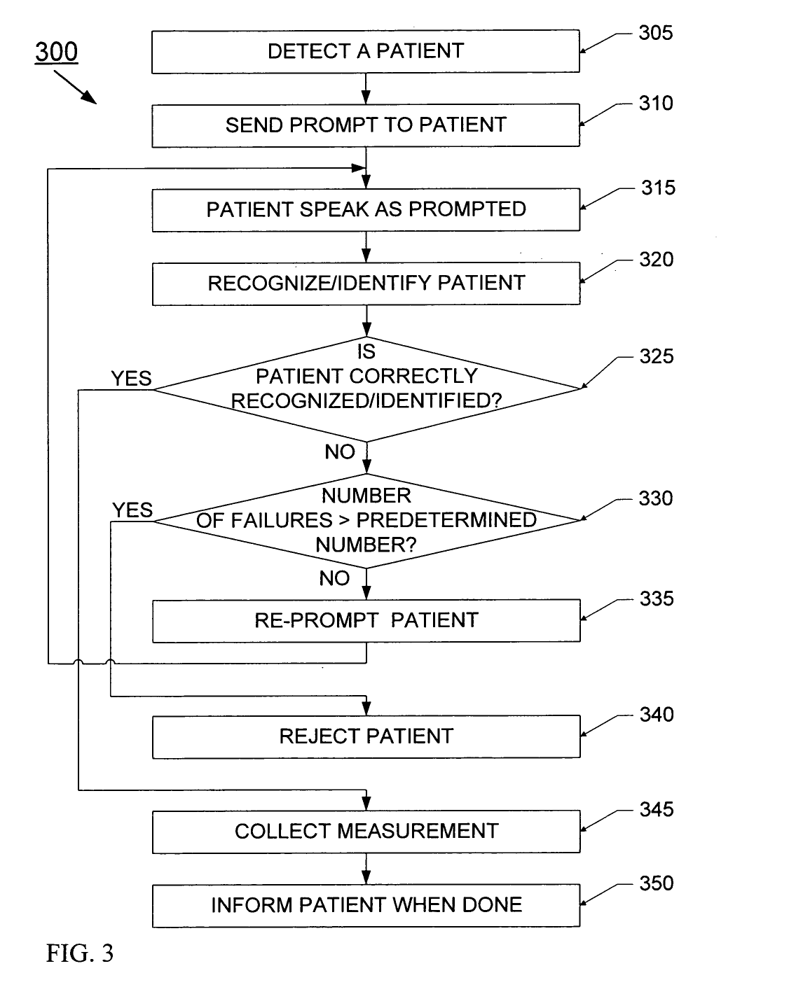

FIG. 3 is a flowchart of one example process 300 for a PHS to collect data from a patient and to match the data so collected to a correct profile. At block 305, a patient may be detected at a peripheral or at the center console of a PHS At block 310, a prompt may be sent to the detected patient. The prompt can be either a voice prompt or a text prompt to ask the patient to speak a phrase/sentence so that s/he can be recognized or identified. At block 315, the patient may speak as required. In case, the patient does not speak as required as waiting for a pre-determined amount of time, the patient may be prompted to speak again. Also at block 315, the patient's speech may be partially processed and the intermediate results may be transmitted to the PHS for speaker recognition/identification. In another embodiment, the patient speech may be directly transmitted to the PHS for processing. At block 320, speaker recognition/identification may be performed for the patient via his/her speech. At block 325, it may be determined whether the patient is correctly recognized/identified. If the answer is positive, the PHS may retrieve the patient profile from a patient database. The patient may be prompted to proceed to conduct medical measurement at block 345. Any measurement data is also collected by the PHS and stored in the patient profile at block 345. In another embodiment, medical measurement data may be stored in the patient's medical record stored in a data storage device along with the patient profile. At block 350, the patient may be informed via voice or text that s/he is done and may proceed for another measurement at the same or a different peripheral if s/he desires.

If it is determined that the patient is not correctly recognized/identified at block 325, it may be further determined whether the number for failed recognition/identification has exceeded a predetermined number (e.g., 3 times) at block 330. If it is, the PHS may reject the patient and suggest the patient to seek health from a representative at block 340; otherwise, the patient may be re-prompt via voice or text to speak the same or a new phrase/sentence at block 340 to go through the speaker recognition/identification process again from block 315 through block 330.

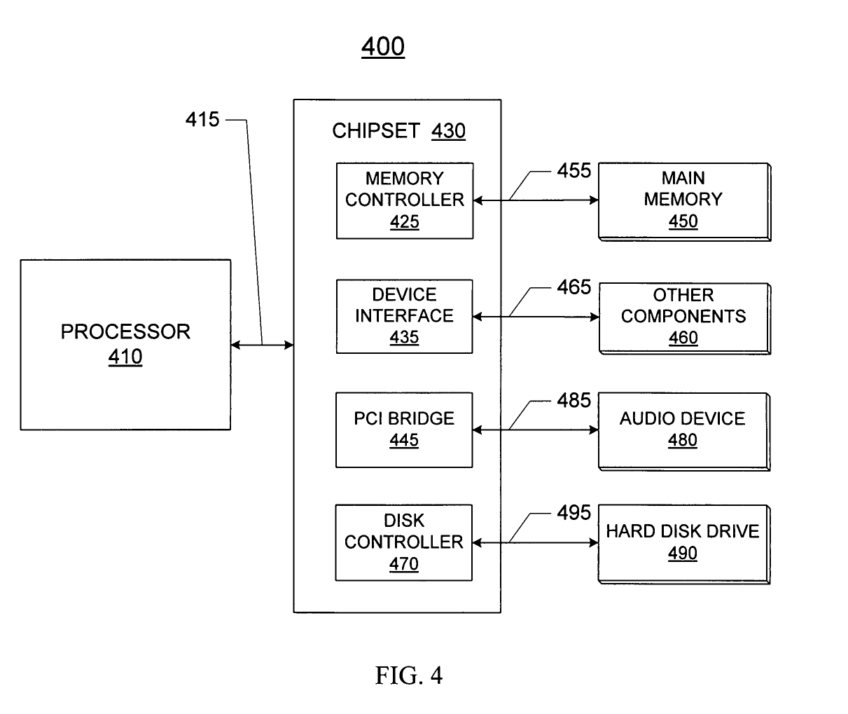

A PHS using speaker recognition/identification technology as described above may be implemented in a computing system 400 as shown in FIG. 4. Computing system 400 may comprise one or more processors 410 coupled to a system interconnect 415. Processor 410 may have multiple or many processing cores (for brevity of description, term “multiple cores” will be used hereinafter to include both multiple processing cores and many processing cores). The computing system 400 may also include a chipset 430 coupled to the system interconnect 415. Chipset 430 may include one or more integrated circuit packages or chips. Chipset 430 may comprise one or more device interfaces 435 to support data transfers to and/or from other components 460 of the computing system 400 such as, for example, keyboards, mice, network interfaces, etc. The device interface 435 may be coupled with other components 460 through a bus 465. Chipset 430 may be coupled to a Peripheral Component Interconnect (PCI) bus 485. Chipset 430 may include a PCI bridge 445 that provides an interface to the PCI bus 485. The PCI Bridge 445 may provide a data path between the processor 410 as well as other components 460, and peripheral devices such as, for example, an audio device 480. Although not shown, other devices may also be coupled to the PCI bus 485.

Additionally, chipset 430 may comprise a memory controller 425 that is coupled to a main memory 450 through a memory bus 455. The main memory 450 may store data and sequences of instructions that are executed by multiple cores of the processor 410 or any other device included in the system. The memory controller 425 may access the main memory 450 in response to memory transactions associated with multiple cores of the processor 410, and other devices in the computing system 400. In one embodiment, memory controller 425 may be located in processor 410 or some other circuitries. The main memory 450 may comprise various memory devices that provide addressable storage locations which the memory controller 425 may read data from and/or write data to. The main memory 450 may comprise one or more different types of memory devices such as Dynamic Random Access Memory (DRAM) devices, Synchronous DRAM (SDRAM) devices, Double Data Rate (DDR) SDRAM devices, or other memory devices.

Moreover, chipset 430 may include a disk controller 470 coupled to a hard disk drive (HDD) 490 (or other disk drives not shown in the figure) through a bus 495. The disk controller allows processor 410 to communicate with the HDD 490. In some embodiments, disk controller 470 may be integrated into a disk drive (e.g., HDD 490). There may be different types of buses coupling disk controller 470 and HDD 490, for example, the advanced technology attachment (ATA) bus and PCI Express (PCI-E) bus.

An OS (not shown in the figure) may run in processor 410 to control the operations of the computing system 400. The OS may facilitate a patient management application (such as 210 in FIG. 2) to run in the computing system. The OS may also facilitate other components of the PHS such as speaker recognition/identification module, data collector, and detector & prompter as shown in FIG. 2 to run in the computing system. Additionally, user interface 220 as shown in FIG. 2 may an input/output device of the computing system itself.

Although an example embodiment of the disclosed subject matter is described with reference to block and flow diagrams in FIGS. 1-4, persons of ordinary skill in the art will readily appreciate that many other methods of implementing the disclosed subject matter may alternatively be used. For example, the order of execution of the blocks in flow diagrams may be changed, and/or some of the blocks in block/flow diagrams described may be changed, eliminated, or combined.

In the preceding description, various aspects of the disclosed subject matter have been described. For purposes of explanation, specific numbers, systems and configurations were set forth in order to provide a thorough understanding of the subject matter. However, it is apparent to one skilled in the art having the benefit of this disclosure that the subject matter may be practiced without the specific details. In other instances, well-known features, components, or modules were omitted, simplified, combined, or split in order not to obscure the disclosed subject matter.

Various embodiments of the disclosed subject matter may be implemented in hardware, firmware, software, or combination thereof, and may be described by reference to or in conjunction with program code, such as instructions, functions, procedures, data structures, logic, application programs, design representations or formats for simulation, emulation, and fabrication of a design, which when accessed by a machine results in the machine performing tasks, defining abstract data types or low-level hardware contexts, or producing a result.

For simulations, program code may represent hardware using a hardware description language or another functional description language which essentially provides a model of how designed hardware is expected to perform. Program code may be assembly or machine language, or data that may be compiled and/or interpreted. Furthermore, it is common in the art to speak of software, in one form or another as taking an action or causing a result. Such expressions are merely a shorthand way of stating execution of program code by a processing system which causes a processor to perform an action or produce a result.

Program code may be stored in, for example, volatile and/or non-volatile memory, such as storage devices and/or an associated machine readable or machine accessible medium including solid-state memory, hard-drives, floppy-disks, optical storage, tapes, flash memory, memory sticks, digital video disks, digital versatile discs (DVDs), etc., as well as more exotic mediums such as machine-accessible biological state preserving storage. A machine readable medium may include any mechanism for storing, transmitting, or receiving information in a form readable by a machine, and the medium may include a tangible medium through which electrical, optical, acoustical or other form of propagated signals or carrier wave encoding the program code may pass, such as antennas, optical fibers, communications interfaces, etc. Program code may be transmitted in the form of packets, serial data, parallel data, propagated signals, etc., and may be used in a compressed or encrypted format.

Program code may be implemented in programs executing on programmable machines such as mobile or stationary computers, personal digital assistants, set top boxes, cellular telephones and pagers, and other electronic devices, each including a processor, volatile and/or non-volatile memory readable by the processor, at least one input device and/or one or more output devices. Program code may be applied to the data entered using the input device to perform the described embodiments and to generate output information. The output information may be applied to one or more output devices. One of ordinary skill in the art may appreciate that embodiments of the disclosed subject matter can be practiced with various computer system configurations, including multiprocessor or multiple-core processor systems, minicomputers, mainframe computers, as well as pervasive or miniature computers or processors that may be embedded into virtually any device. Embodiments of the disclosed subject matter can also be practiced in distributed computing environments where tasks may be performed by remote processing devices that are linked through a communications network.

Although operations may be described as a sequential process, some of the operations may in fact be performed in parallel, concurrently, and/or in a distributed environment, and with program code stored locally and/or remotely for access by single or multi-processor machines. In addition, in some embodiments the order of operations may be rearranged without departing from the spirit of the disclosed subject matter. Program code may be used by or in conjunction with embedded controllers.

While the disclosed subject matter has been described with reference to illustrative embodiments, this description is not intended to be construed in a limiting sense. Various modifications of the illustrative embodiments, as well as other embodiments of the subject matter, which are apparent to persons skilled in the art to which the disclosed subject matter pertains are deemed to lie within the scope of the disclosed subject matter.

What is claimed is:

1. A personal health system, comprising:
a speaker recognition/identification module to recognize/identify via voice a patient;
a patient management application to authorize the patient to use the personal health system if the patient is successfully recognized/identified by the speaker recognition/identification module, the patient using the personal health system to conduct medical measurement; and
a data collector to collect data from the medical measurement conducted by the patient and to transmit the data to the patient management application.

2. The system of claim 1, wherein the patient uses the personal health system at one of a center console of the personal health system and a medical peripheral coupled to the personal health system.

3. The system of claim 2, wherein the medical peripheral comprises an voice input/output device to accept voice input from the patient and to play back voice output to the patient from the personal health system.

4. The system of claim 2, further comprising a detector & prompter to detect the patient at one of the center console and the medical peripheral and to prompt the patient to speak a specified phrase/sentence.

5. The system of claim 4, wherein the speaker recognition/identification module receives speech from the patient and uses the speech to recognize/identify the patient.

6. The system of claim 1, further comprises a data storage device to store a profile for the patient, the patient profile including the medical measurement data for the patient.

7. The system of claim 6, wherein the patient management application further stores the medical measurement data collected by the data collector to the patient profile in the data storage device.

8. The system of claim 1, wherein the personal health system is implemented using a computing system having at least one processor and a main memory coupled to the processor to store instructions and data for the patient management application.

9. A method for accessing a personal health system, comprising:
detecting a patient at one of a center console of the personal health system and a medical peripheral coupled to the personal health system;
receiving input speech from the detected patient;
recognizing/identifying the detected patient using the input speech;
authorizing the patient to access the personal health system via one of the center console and the medical peripheral, if the patient is successfully recognized/identified; and
collecting medical measurement data obtained from the patient by a medical device at one of the center console and the medical peripheral.

10. The method of claim 9, wherein the medical peripheral comprises an voice input/output device to accept voice input from the patient and to play back voice output to the patient from the personal health system.

11. The method of claim 9, further comprising prompting the detected patient to produce the input speech by speaking a specified phrase/sentence.

12. The method of claim 9, further comprising re-prompting the patient to produce another input speech by speaking at least one of the same or a new phrase/sentence, if the patient fails to be recognized/identified.

13. The method of claim 12, further comprising rejecting the patient and recommending the patient to seek help from a human representative if the patient fails to be recognized/identified for a pre-determined consecutive number of times.

14. The method of claim 9, further comprising:
retrieving a profile for the detected patient from a data storage device once the patient is successfully recognized/identified;
adding the collected medical measurement data to the patient profile; and
storing the updated patient profile back to the data storage device.

15. The method of claim 9, further comprising accessing medical record of the patient by the patient once the patient is successfully recognized/identified, the medical record including the patient profile.

16. The method of claim 9, further comprising enabling multiple patients to access the personal health system at different locations simultaneously if each patient is successfully recognized/identified, the different locations including the center console and multiple medical peripherals.

17. An article comprising a machine-readable medium that contains instructions, which when executed by a processing platform, cause said processing platform to perform operations for accessing a personal health system, the operations comprising:
detecting a patient at one of a center console of the personal health system and a medical peripheral coupled to the personal health system;
receiving input speech from the detected patient;
recognizing/identifying the detected patient using the input speech;
authorizing the patient to access the personal health system via one of the center console and the medical peripheral, if the patient is successfully recognized/identified; and
collecting medical measurement data obtained from the patient by a medical device at one of the center console and the medical peripheral.

18. The article of claim 17, wherein the operations further comprises prompting the detected patient to produce the input speech by speaking a specified phrase/sentence.

19. The article of claim 17, wherein the operations further comprise re-prompting the patient to produce another input speech by speaking at least one of the same or a new phrase/sentence, if the patient fails to be recognized/identified.

20. The article of claim 19, wherein the operations further comprise rejecting the patient and recommending the patient to seek help from a human representative if the patient fails to be recognized/identified for a pre-determined consecutive number of times.

21. The article of claim 17, wherein the operations further comprise:
retrieving a profile for the detected patient from a data storage device once the patient is successfully recognized/identified;
adding the collected medical measurement data to the patient profile; and
storing the updated patient profile back to the data storage device.

22. The article of claim 17, wherein the operations further comprise accessing medical record of the patient by the patient once the patient is successfully recognized/identified, the medical record including the patient profile.

23. The article of claim 17, wherein the operations further comprise enabling multiple patients to access the personal health system at different locations simultaneously if each patient is successfully recognized/identified, the different locations including the center console and multiple medical peripherals.
